(19) United States
(12) Patent Application Publication
(10) Pub. No.: US 2008/0170108 A1
(43) Pub. Date: Jul. 17, 2008

(54) INK TANK AND INKJET PRINTER HAVING THE SAME

(75) Inventors: In-su LEE, Suwon-si (KR); Sung-wook Kang, Seoul (KR); Jin-ho Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/773,500

(22) Filed: Jul. 5, 2007

(30) Foreign Application Priority Data
Jan. 17, 2007 (KR) 2007-5425

(51) Int. Cl. B41J 2/195; B41J 2/175

(52) U.S. Cl. 347/85

(57) ABSTRACT

An ink tank of an inkjet printer includes a housing that stores ink; an ink intake unit formed through a lateral wall of the housing and that is openable and closeable to intake ink from the outside; an ink discharge unit formed through a lateral wall of the housing and that is openable and closeable to discharge ink to the outside; and a filter unit that is connected to the ink discharge unit and is installed closer to the bottom of the housing than the ink discharge unit, the filter unit including a filter that filters dust included in the ink that flows to the ink discharge unit.

### CROSS-REFERENCE TO RELATED APPLICATIONS

This application claims the benefit of Korean Application No. 2007-5425, filed Jan. 17, 2007, in the Korean Intellectual Property Office, the disclosure of which is incorporated herein by reference.

### BACKGROUND OF THE INVENTION

1. Field of the Invention

Aspects of the present invention relate to an inkjet printer, and more particularly, to an inkjet printer having an ink tank that includes a built-in filter and an air intake/outtake control unit.

2. Description of the Related Art

An inkjet printer is an apparatus that prints an image by ejecting ink from a printhead onto a printing paper at a predetermined distance from an upper surface of the printing paper. The printhead includes a nozzle unit having a plurality of nozzles that eject ink onto the printing paper. Examples of inkjet printers include printers having a shuttle type printhead that moves reciprocally in a direction perpendicular to the moving direction of the printing paper (typically, in a widthwise direction of a printing paper) and high-speed printers having a fixed printhead with a nozzle unit having a length corresponding to the width of the printing paper, so that only the printing paper moves during printing.

The inkjet printer typically includes a negative pressure regulator to maintain the ink meniscuses inside the nozzles of the nozzle unit so that ink cannot be ejected from the nozzles except when required.

FIG. 1 is a cross-sectional view of a conventional negative pressure regulator. Referring to FIG. 1, a main body 1 includes an ink flow channel 7 and a needle 2 in an inlet portion of the main body 1. When the needle 2 is connected to an ink cartridge (not shown) that stores ink, the ink enters into the ink flow channel 7.

A diaphragm 5, which can move up and down, is provided in a predetermined space 8 of the ink flow channel 7 of the main body 1. A valve 3 is supported by a spring 6 below the diaphragm 5 so that the valve 3 can contact the diaphragm 5. The valve 3 is in a position of blocking a portion of the ink flow channel 7 so that ink cannot flow. When a negative pressure is generated in the main body 1 due to the ejection of ink, the diaphragm 5 moves to a lower side and the valve 3 is also lowered together with the diaphragm 5. Hence, ink inlets 4 blocked by the valve 3 are opened, and thus, ink enters into the space 8. When the space 8 is completely filled with ink, the diaphragm 5 is pushed upward due to the ink pressure and the valve 3 also moves upwards due to the restoration force of the spring 6 to block the ink flow channel 7.

The ink flow channel 7 includes a filter 9 for removing impurities such as dust included in the ink. When the filter 9 is blocked by dust and air bubbles such that the flow of ink is inhibited, the filter 9 must be replaced. However, since the filter 9 is located inside the negative pressure regulator, it is difficult to replace only the filter 9.

### SUMMARY OF THE INVENTION

Aspects of the present invention provide an ink tank and an inkjet printer that includes the ink tank. The ink tank has an air intake/outtake control unit that is always soaked in ink and a built-in filter that prevents bubbles from traveling with the ink from the ink tank.

According to an aspect of the present invention, there is provided an ink tank comprising: a housing that stores ink, the housing including a bottom and lateral walls; an ink intake unit formed through a lateral wall of the housing wherein the ink intake unit is openable and closeable to take ink from the outside; an ink discharge unit formed through a lateral wall of the housing wherein the ink discharge unit is openable and closeable to discharge ink to the outside; and a filter unit that is connected to the ink discharge unit and installed closer to the bottom of the housing than the ink discharge unit, the filter unit including a filter that filters dust from the ink that flows to the ink discharge unit.

According to another aspect of the present invention, there is provided an inkjet printer comprising printhead, an ink tank and a negative pressure regulator controls a supply of ink to the printhead wherein the ink cartridge comprises a housing in which ink is stored, the housing including a bottom and lateral walls; an ink intake unit formed through a lateral wall of the housing wherein the ink intake unit is openable and closeable to intake ink from the outside; an ink discharge unit formed through the same lateral wall of the housing in which the ink intake unit is formed, wherein the ink intake unit is openable and closeable to discharge ink to the outside; and a filter unit that is connected to the ink discharge unit, and is installed closer to the bottom of the housing than the ink discharge unit, the filter unit including a filter that filters dust included in the ink that flows to the ink discharge unit, and wherein the negative pressure regulator comprises an ink inlet boss and an ink outlet boss that are inserted into the ink discharge unit and the ink intake unit, respectively of the ink tank when the ink tank is connected to the negative pressure regulator.

According to another aspect of the present invention, there is provided a method of operating an inkjet printer, the method comprising providing an inkjet printer that includes a printhead; an ink tank; and a negative pressure regulator that controls a supply of ink to the printhead, wherein the ink tank comprises a housing in which ink is stored, the housing including a bottom; an ink intake unit formed through a lateral wall of the housing and which is openable and closeable to intake ink from an external source and into the housing; an ink discharge unit formed through the housing and which is openable and closeable to discharge ink to the negative pressure regulator; a filter unit that is connected to the ink discharge unit and is installed between the bottom of the housing and the ink discharge unit, the filter unit including a filter that filters dust included in the ink that flows to the ink discharge unit, and a sensor positioned adjacent to the bottom of the housing, wherein the sensor detects if an amount of ink remaining in the housing falls below a predetermined minimum level, and wherein a height from the bottom of the housing to the filter is less than the height from the bottom of the housing to the sensor and wherein the negative pressure regulator comprises an ink inlet boss and an ink outlet boss that are inserted into the ink discharge unit and the ink intake unit, respectively, of ink tank when the ink tank is connected to the negative pressure regulator, conducting printing with the inkjet printer in which ink is passed through the filter to the ink discharge unit, the negative pressure regulator and the printhead, wherein the ink tank of the inkjet printer has an initial level of ink that is above the predetermined level and wherein the level of ink falls while the printing is conducted; and replacing or refilling the ink tank with ink when sensor detects that the level of ink has fallen to or below the predetermined level and before the level of ink has fallen to the level of the filter.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a conventional negative pressure regulator;

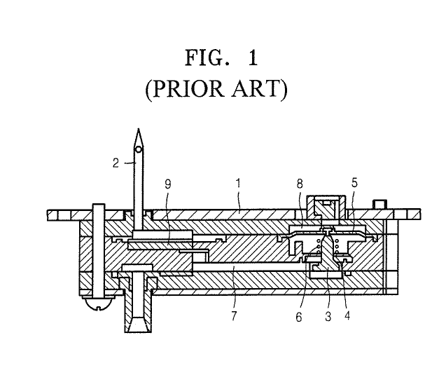

FIG. 2 is a schematic drawing of an inkjet printer having a plurality of ink tanks, according to an embodiment of the present invention;

FIG. 3 is a perspective view illustrating an ink tank according to an embodiment of the present invention;

FIG. 4 is a partial perspective view illustrating the inside of a lateral wall of the ink tank of FIG. 3, according to an embodiment of the present invention;

FIG. 5 is a cross-sectional view illustrating the ink tank of FIG. 3 before being mounted on a negative pressure regulator;

FIG. 6 is a cross-sectional view illustrating the ink discharge unit of the ink tank of FIG. 3 after the ink discharge unit is mounted to an ink inlet boss of a negative pressure regulator;

FIG. 7 is a cross-sectional view illustrating the ink discharge unit and intake/outtake control unit of the ink tank of FIG. 3 when the ink tank is not connected to a negative pressure regulator and showing the intake/outtake control unit in a closed position;

FIG. 8 is a cross-sectional view illustrating the ink discharge unit and intake/outtake control unit of the ink tank of FIG. 3 after the ink discharge unit is mounted to an ink inlet boss of a negative pressure regulator and showing the intake/outtake control unit in an open position; and

FIGS. 9 and 10 are graphs showing pressure loss at a filter with and without air mixed in ink.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

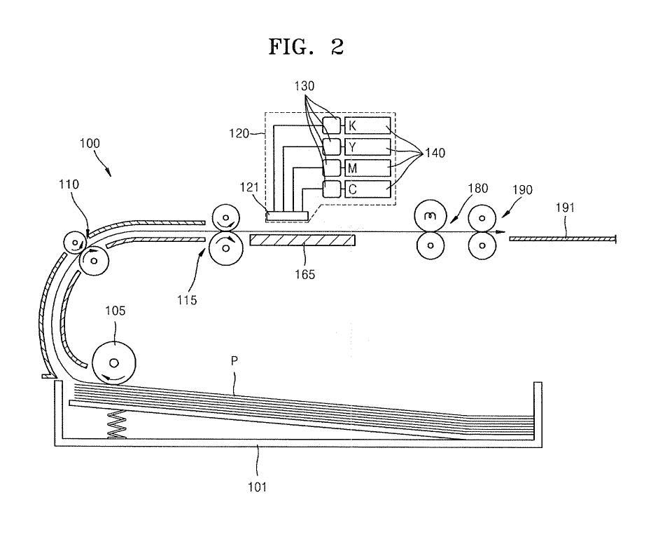

FIG. 2 is a schematic drawing of an inkjet printer 100 having at least one ink tank according to an embodiment of the present invention. The inkjet printer 100 of FIG. 2 is a non-limiting example, and it should be understood that features of the inkjet printer 100 can be different from what are shown. Further, the inkjet printer 100 can be incorporated in a copier or multifunctional device. Referring to FIG. 2, the inkjet printer 100 includes a paper moving system that moves paper P in a predetermined direction and a printhead 121 that forms an image on the paper P by ejecting ink thereon. In FIG. 2, the printhead 121 is an array type printhead. However, it is to be understood that a shuttle type printhead can be also used. Moreover, other types of printing media other than paper may be used.

The paper moving system shown in FIG. 2 includes a conveyor roller unit 110 that guides the paper P to pass under the printhead 121, and a paper discharge roller unit 190 that discharges the paper P on which an image has been formed by ejecting ink thereon, to an output tray 191. The conveyor roller unit 110 and the paper discharge roller unit 190 each includes a pair of rollers (that is, a driving roller and a driven roller), which are installed to contact each other with pressure. The paper P passes between the pairs of rollers. A registration roller unit 115 also includes a pair of rollers that aligns the paper P so that an image is formed on a desired portion of the paper P.

The inkjet printer 100 includes a paper supply cassette 101. The cassette 101 holds a stack of papers S in which papers P on which images are to be printed. A pick up roller 105 picks up each sheet of paper P stacked in the paper supply cassette 101. The inkjet printer 100 includes a fixing unit 180 that fixes an image on the paper P by fusing ink of the image. The fixing unit 180 includes a heating roller that generates heat, and a pressing roller that is installed to face the heating roller to press the paper P against the heating roller.

The ink cartridge 120 is mounted between the registration roller unit 115 and the fixing unit 180. As shown, the ink cartridge 120 includes four ink tanks 140C, 140M, 140Y, and 140K that accommodate cyan, magenta, yellow, and black inks, four negative pressure regulators 130C, 130M, 130Y, and 130K, and the printhead 121. However, it is to be understood that other numbers of ink tanks can be used, that only one ink tank can be used, and that the tanks can have other colors of ink besides or in addition to cyan, magenta, yellow and black.

The four negative pressure regulators 130C, 130M, 130Y, and 130K control the negative pressure of inks entering the printhead 121 from the four ink tanks 140C, 140M, 140Y, and 140K to prevent the penetration of air bubbles into the printhead 121 and/or to prevent the inks from leaking unnecessarily by maintaining ink meniscuses inside nozzles in the printhead 121. While not required in all aspects, it is to be understood that the tanks 140 can be removable individually or as a single displaceable unit. Further, it is to be understood that the tank 140 need not be removable, such as when the tanks 140 can be refilled in place.

A platen 165 is provided under the printhead 121 to support papers P on which images are formed while passing under the printhead 121. Thus, a uniform gap is maintained between the papers P that pass under the printhead 121 and the printhead 121.

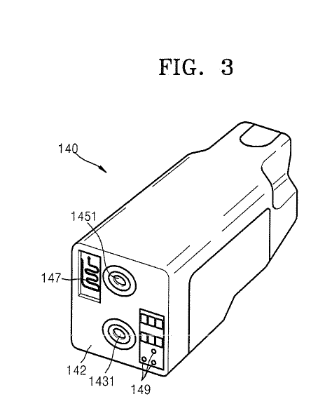

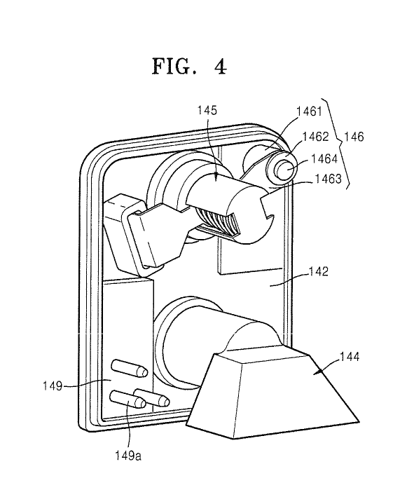

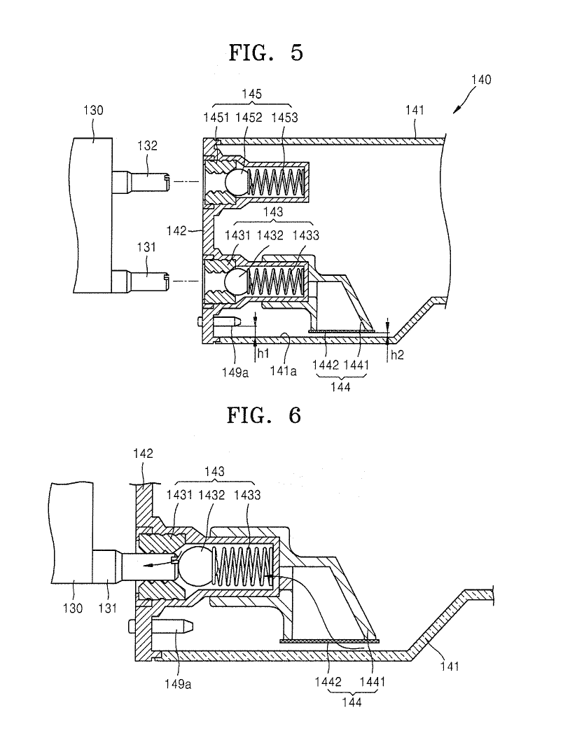

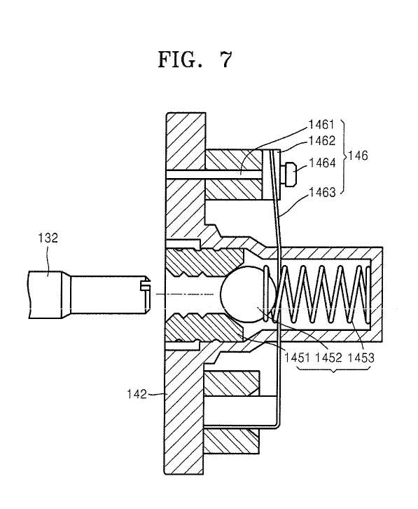

FIG. 3 is a perspective view illustrating an ink tank 140 according to an embodiment of the present invention, and FIG. 4 is a partial perspective view illustrating the inside of a lateral wall 142 of the ink tank 140 of FIG. 3, according to an embodiment of the present invention. FIG. 5 is a cross-sectional view illustrating the ink tank 140 prior to being mounted on a negative pressure regulator 130, and FIG. 6 is a cross-sectional view illustrating a case where an ink discharge unit 143 of the ink tank 140 is mounted on an ink inlet boss 131 of the negative pressure regulator 130.

Referring to FIGS. 3 through 5, the ink tank 140 includes a housing 141 in which an ink is stored. The ink discharge unit 143 is provided on the lateral wall 142 of the housing 141 to discharge the ink to the outside of the housing 141. A filter unit 144 filters dust included in the ink discharged through the ink discharge unit 143. An ink intake unit 145 is provided on a lateral wall 142 of the housing 141 to take in ink from the outside. An air intake/outtake control unit 146 is installed on the lateral wall 142 of the housing 141 adjacent to the ink intake unit 145 to control air coming into and going out of the housing 141. While not required in all aspects, the lateral wall 142 of the housing 141 shown in FIGS. 3 through 5 is a surface facing the negative pressure regulator 130.

The ink discharge unit 143 includes an ink outlet 1431 formed through the lateral wall 142 of the housing 141, a stopper 1432 having a predetermined diameter to block the ink outlet 1431, and a resilient member 1433 that applies an elastic force against the stopper to block the ink outlet 1431. As non-limiting examples, the stopper 1432 may have a ball shape as shown or any other suitable shape for blocking the ink outlet 1431, and the resilient member 1433 may be a spring as shown. When the stopper 1432 blocks the ink outlet 1431, the ink stored in the housing 141 is not discharged to the outside.

The ink intake unit 145 is installed on the same lateral wall 142 of the housing 141 on which the ink discharge unit 143 is provided. The ink intake unit 145 is located at a higher position from a bottom 141a of the housing 141 than the ink discharge unit 143. That is, the shown ink discharge unit 143 is located closer to the bottom 141a of the housing 141 than the ink intake unit 145. As used herein, the term “bottom of the housing” refers to the portion of the housing 141 toward which ink flows by force of gravity when the ink tank 140 is operationally positioned in an inkjet printer 100. However, it is to be understood that the relative positions and locations of the units 143 and 145 can be different from what is shown.

The ink intake unit 145 has the same configuration as the ink discharge unit 143. The ink intake unit 145 includes an ink inlet 1451 formed through the lateral wall 142 of the housing 141, a stopper 1452 having a predetermined diameter so as to block the ink inlet 1451 and a resilient member 1453 that applies an elastic force to the stopper 1452 against the ink inlet 1451. As non-limiting examples, the stopper 1452 may have a ball shape and the resilient member 1453 may be a spring. When the stopper 1452 blocks the ink inlet 1451 due to the elastic force of the spring 1453, ink cannot enter from the outside.

A filter unit 144 is connected to the ink discharge unit 143 such that ink is filtered before being discharged from the ink tank 140. The filter unit 144 includes a filter 1442 that is opened to face the bottom 141a of the housing 141 and a filter case 1441 that enables ink that passes through the filter 1442 to flow towards the ink discharge unit 143. The filter 1442 is positioned as close as possible to the bottom 141a of the housing 141 such that the filter 1442 remains soaked with ink until the ink tank 140 is completely empty or almost completely empty due to the complete consumption of the ink. Accordingly, until the ink tank 140 is replaced, all ink that is discharged to the outside must pass through the filter 1442. In particular, the filter 1442 may be between the ink discharge unit 143 and the bottom 141a of the ink tank 140. The cross-section of the filter case 1441 according to the present embodiment is shown as being a rectangular shape. However, the filter case 1441 according to aspects of the present invention is not limited to such shape, and the filter case 1441 can have various cross-section shapes such as, for example, a circular shape or a trapezoidal shape.

While not required in all aspects, sensors 149 are provided on the lateral wall 142 of the housing 141 to detect the level of ink stored in the housing 141. The one or more sensors 149 may notify a user when the ink level in the ink tank 140 falls below a predetermined level. For example, at least one sensor 149a may be positioned closest to the bottom 141a of the housing 141. When the sensor 149a located closest to the bottom 141a of the housing 141 detects that the ink level has fallen to the level of the sensor 149a, the ink level is the lowest, and thus, the ink tank 140 must be refilled or replaced.

As depicted in FIG. 5, the filter 1442 is positioned in the housing 141 to be between the bottom 141a of the housing 141 and the lowest sensor 149a. What is meant herein by the phrase “between the bottom 141a of the housing 141 and the lowest sensor 149a” is that the filter is closer to the bottom 141a of the housing 141 than the lowest sensor 149a In other words, if a distance from the bottom 141a of the housing 141 to the sensor 149a is height h₁, and a distance from the bottom 141a of the housing 141 to the filter 1442 is height 2 h₂, then h₁>h₂. Accordingly, by having the filter 1442 at a level between the lowermost sensor and the bottom 141a, even if the ink level were to fall to the level at which the sensor 149a indicates that ink tank 140 must be refilled or replaced, there would still be enough ink left in the ink tank 140 such that the filter 1442 would remain soaked in ink.

Further, the configuration of the ink tank 140 described above prevents air bubbles that may be mixed in the ink from interfering with the ink jet printing. This is because air bubbles that may become mixed in the ink are lighter than the ink. Thus, the air bubbles float up to the surface of the ink. Since the filter 1442 is positioned close to the bottom 141a of the housing 141, the level of the ink in the ink tank 140 never drops to the level of the filter 1442, and the air bubbles therefore cannot pass through the filter 1442 and on to the negative pressure regulator 130 or the printhead 121 and cannot interrupt the flow of ink that passes through the filter 1442.

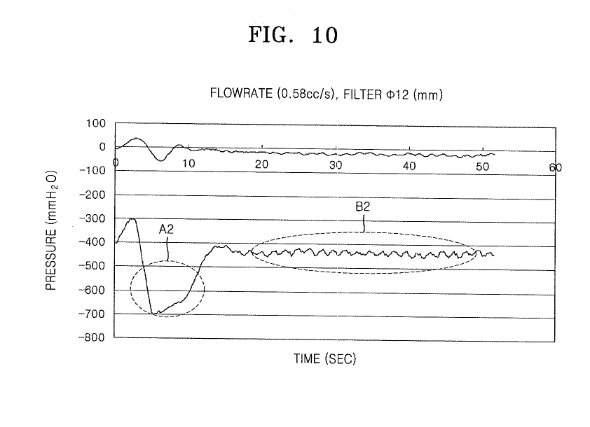

FIGS. 9 and 10 are graphs showing pressure loss at a filter with and without air mixed in ink.

Referring to FIG. 9, pressure variations of ink were measured at a flowrate of 0.58 cc/sec through a circular filter having a diameter of 16 mm. The X axis indicates time and the Y axis indicates pressure in mmH₂O. The upper graph shows pressure variation of ink prior to passing the filter. It is seen that the ink enters the filter with almost at a constant pressure.

The lower graph shows the pressure variation of ink after the ink passes through the filter. A portion of the lower graph indicated by A1 represents a pressure drop when ink with air bubbles passes through the filter. A portion indicated by B1 represents a pressure drop when ink without air bubbles passes through the filter. Since the pressure drop in portion A1 is greater than in portion B1, it is seen that when air bubbles block the filter, the flow of ink through the filter is interrupted. Accordingly, in order to overcome the pressure loss caused by the air bubbles, a further pressure corresponding to the pressure drop difference between A1 and B1 must be applied.

Referring to FIG. 10, pressure variations of ink were measured at a flowrate of 0.58 cc/sec through a circular filter having a diameter of 12 mm. Portions A2 and B2 are similar to the portions A1 and B1 in FIG. 9, and show an increased pressure drop as the size of the filter is decreased. That is, when the size of the filter is small, the pressure drop increases at the same flowrate.

When the ink contains air bubbles, the air bubbles interrupt the flow of ink through the filter since the air bubbles block the filter. However, in the present embodiment, the filter 1442 is always soaked in the ink at a low position of the ink tank 140. Therefore, since air bubbles tend to float upward to the surface and thus, in the opposite direction from where the filter 1442 is located, the interruption of ink flow due to the blocking of the filter 1442 with air bubbles cannot occur.

Referring to FIG. 53 the negative pressure regulator 130 includes an ink inlet boss 131 and an ink outlet boss 132. The ink inlet boss 131 corresponds to and engages with the ink discharge unit 143 of the ink tank. The ink outlet boss 132 corresponds to and engages with the ink intake unit 145 of the ink tank. When the ink tank 140 is not mounted on the negative pressure regulator 130, since the stoppers 1432 and 1452 block the ink outlet 1431 and the ink inlet 1451, respectively, by the elastic force of the resilient members 1433 and 1453, the ink cannot enter or exit the housing 141.

Referring to FIG. 6, when the ink tank 140 is mounted on the negative pressure regulator 130, the ink inlet boss 131 of the negative pressure regulator 130 is inserted into the ink outlet 1431 of the ink tank 140. The ink outlet boss 132 of the negative pressure regulator is also inserted into the ink inlet 1451 of the ink tank 140. For convenience of explanation, in FIG. 6, an opening operation of the ink outlet 1431 of the ink tank 140 will be described.

When the ink inlet boss 131 of the negative pressure regulator 130 is inserted into the ink outlet 1431 of the ink tank 140, the ink inlet boss 131 pushes the stopper 1432 inwards of the housing 141. Thus, the stopper 1432 is separated a predetermined distance from the ink inlet 1451. At this point, the ink stored in the housing 141 flows into the ink inlet boss 131 through a gap between the ink outlet 1431 and the stopper 1432 due to a pressure difference.

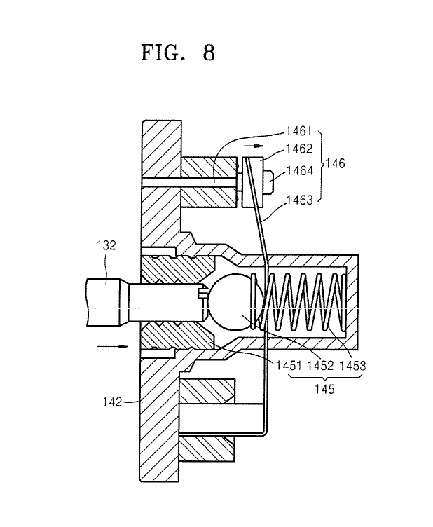

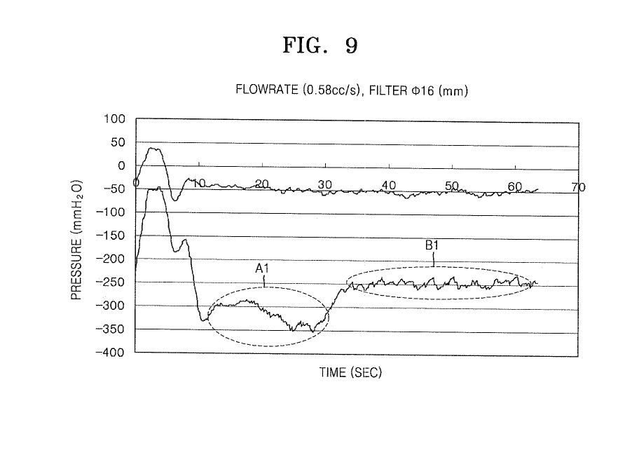

FIG. 7 is a cross-sectional view illustrating the ink intake unit 145 and air intake/outtake control unit 146 of the ink tank 140 of FIG. 3 when the ink tank 140 is not connected to a negative pressure regulator 130 and showing the air intake/outtake control unit 146 in a closed position. FIG. 8 is a cross-sectional view illustrating the ink intake unit 143 and air intake/outtake control unit 146 of the ink tank 140 of FIG. 3 after the ink intake unit 143 is mounted to an ink outlet boss 132 of a negative pressure regulator 130 and showing the intake/outtake control unit 146 in an open position.

Referring to FIGS. 7 and 8, the air intake/outtake control unit 146 includes an air hole 1461 formed through the lateral wall 142 of the housing 141 so that air can pass therethrough. A valve 1462 is supported by a guide axis 1464 located inside the housing 141 to open and close a side of the air hole 1461 by sliding. A supporting unit 1463having a main body that is supported by the resilient member 1453 of the ink intake unit 145, an end of which is connected to the valve 1462, and other end of which is fixed on the lateral wall 142 of the housing 141. As depicted in FIG. 3, the other end of the air hole 1461 formed on an outer side of the housing 141 may be windingly formed so that the air passageway to and from the housing 141 is constricted.

The supporting unit 1463 is supported by the resilient member 1453 of the ink intake unit 145 so as to move in connection with the resilient member 1453. Accordingly, the resilient member 1453 moves when the ink intake unit 145 is operated. Thus, the operation of the valve 1462 closes or opens the air hole 1461.

As depicted in FIG. 7, in a state that the ink outlet boss 132 is not inserted into the ink inlet 1451 (that is, when the ink tank 140 is not connected to the negative pressure regulator 130), the stopper 1452 blocks the ink inlet 1451 due to an elastic force of the resilient member 1453 and the valve 1462 blocks the air hole 1461. Accordingly, the ink and air cannot travel to and from the housing 141.

As depicted in FIG. 8, in a state that the ink outlet boss 132 is inserted into the ink inlet 1451 (that is, when the ink tank 140 is connected to the negative pressure regulator 130), since the ink outlet boss 132 pushes the stopper 1452 towards an inner side of the housing 141, the resilient member 1453 is compressed in a direction indicated by the arrow, and at this point, the supporting unit 1463 moves together with the resilient member 1453. Accordingly, the valve 1462 also moves along the guide axis 1464 by the supporting unit 1463, and thus, the air hole 1461 is opened. The ink inlet unit 145 of the ink tank 140 may also receive an ink outlet boss 132 from and ink source such as an ink refill supply container so that the ink tank 140 can be refilled instead of thrown away when the ink tank 140 becomes empty.

When the ink tank 140 is connected to the negative pressure regulator 130, the ink inlet boss 131 of the negative pressure regulator 130 is inserted into the ink outlet 1431 of the ink tank 140. The ink outlet boss 132 of the negative pressure regulator 130 is also inserted into the ink inlet 1451 of the ink tank. At this point, the air hole 1461 is also opened. When the ink is discharged to the negative pressure regulator 130 from the ink tank 140 through the ink outlet 1431, air enters into the ink tank 140 from the outside through the air hole 1461 corresponding to the volume change in the ink tank 140 as the ink in the ink tank 140 is reduced.

After a printing operation, ink remaining in the nozzles of the printhead 121 may be recovered by way of the negative pressure regulator to the ink tank 140 using a pump (not shown). When ink is returned to the ink tank 140, the ink volume in the ink tank 140 is increased. Therefore, air corresponding to the volume change in the ink tank 140 is discharged to the outside through the air hole 1461.

As described above, the ink tank according to aspects of the present invention has the following advantages. Since the filter is located in the ink tank instead of in the negative pressure regulator and is kept in an ink-soaked state, there is no possibility that air bubbles can pass through the filter, thereby preventing pressure loss in the ink due to air bubbles. Since the filter is positioned close to the bottom of the ink tank, the ink can be efficiently used. The ink intake and outtake of the ink tank are controlled such that when the ink tank is mounted on a negative pressure regulator, the air hole is opened, and when the ink tank is separated from the negative pressure regulator, the air hole is blocked. Therefore, leakage of ink due to the change of external atmosphere can be prevented.

Although a few embodiments of the present invention has been shown and described, it would be appreciated by those skilled in the art that changes may be made in this embodiment without departing from the principles and spirit of the invention, the scope of which is defined in the claims and their equivalents.

What is claimed is:

1. An ink tank comprising:
a housing that stores ink, the housing including a bottom;
an ink discharge unit formed through the housing and which is openable and closeable to discharge ink from the housing to an outside unit; and
a filter unit that is connected to the ink discharge unit and installed between the bottom of the housing and the ink discharge unit, the filter unit including a filter that filters dust from ink that flows to the ink discharge unit.

2. An ink tank comprising:
a housing that stores ink, the housing including a bottom;
an ink intake unit formed through the housing and which is openable and closeable to take ink from an external source and into the housing;
an ink discharge unit formed through the housing and which is openable and closeable to discharge ink from the housing to an outside unit; and
a filter unit that is connected to the ink discharge unit and installed between the bottom of the housing and the ink discharge unit, the filter unit including a filter that filters dust from ink that flows to the ink discharge unit.

3. The ink tank of claim 2, wherein the ink intake unit and the ink discharge unit are each formed through a same lateral wall of the housing, and the ink discharge unit is located at a position between than the ink intake unit and the bottom of the housing.

4. The ink tank of claim 2, wherein the filter faces the bottom of the housing.

5. The ink tank of claim 2, further comprising a sensor adjacent to the bottom of the housing, wherein the sensor detects if an amount of ink remaining in the housing falls below a minimum level, wherein a height from the bottom of the housing to the filter is less than the height from the bottom of the housing to the sensor.

6. The ink tank of claim 2, further comprising an air intake/outtake control unit that takes in and discharges air into and out of the housing, the air intake/outtake control unit comprising:
an air hole through which air enters and exits the housing;
a valve that closes and opens the air hole; and
a supporting unit having a first end connected to the valve and a second end fixed on a wall of the housing,
wherein the air intake/outtake control unit is operably connected to open and close in connection with opening and closing of the ink intake unit.

7. The ink tank of claim 2, further including a sensor that detects a level of ink in the ink tank and that notifies a user when an ink level in the ink tank is below a predetermined level.

8. An inkjet printer comprising;
a printhead;
an ink tank; and
wherein the ink tank comprises:
a housing in which ink is stored, the housing including a bottom;
an ink intake unit formed through a lateral wall of the housing and which is openable and closeable to intake ink from an external source and into the housing;
an ink discharge unit formed through the housing and which is openable and closeable to discharge ink to the negative pressure regulator; and
a filter unit that is connected to the ink discharge unit and is installed between the bottom of the housing and the ink discharge unit, the filter unit including a filter that filters dust included in the ink that flows to the ink discharge unit, and
wherein the negative pressure regulator comprises an ink inlet boss and an ink outlet boss that are inserted into the ink discharge unit and the ink intake unit, respectively, of ink tank when the ink tank is connected to the negative pressure regulator.

9. The inkjet printer of claim 8, wherein the ink intake unit and the ink discharge unit are each formed through a same lateral wall of the housing, and the ink discharge unit is located at a position between than the ink intake unit and the bottom of the housing.

10. The inkjet printer of claim 8, wherein the filter of the ink tank faces the bottom of the housing.

11. The inkjet printer of claim 8, wherein the ink tank further comprises a sensor positioned adjacent to the bottom of the housing, wherein the sensor detects if an amount of ink remaining in the housing falls below a minimum level, and wherein a height from the bottom of the housing to the filter is less than the height from the bottom of the housing to the sensor.

12. The inkjet printer of claim 8, wherein the ink tank further comprises an air intake/outtake control unit takes in and discharges air into and out of the housing, the air intake/outtake control unit comprising:
an air hole through which air enters and exits the housing;
a valve that closes and opens the air hole; and
a supporting unit having a first end connected to the valve and a second end fixed on a lateral wall of the housing,
wherein the air intake/outtake control unit is operably connected to open and close in connection with opening and closing of the ink intake unit.

13. The inkjet printer of claim 12, wherein the valve of the intake/outtake control unit of the ink tank moves reciprocally along a lengthwise direction of the air hole.

14. The inkjet printer of claim 12, wherein the ink intake unit of the ink tank comprises:
an ink inlet formed through the lateral wall of the housing;
a stopper having a predetermined diameter to block the ink inlet; and
a resilient member that applies an elastic force to the stopper against the ink inlet,
wherein the supporting unit is connected to the resilient member, and wherein the valve of the intake/outtake control unit is coupled to the resilient member of the ink inlet such that the air hole of the intake/outtake control unit is closed and opened by moving of the valve of the intake/outtake control unit in connection with the movement of the resilient member of the ink inlet.

15. The inkjet printer of claim 12, wherein the ink inlet is opened when the stopper is pushed in a direction opposite to a direction of the elastic force of the resilient member when the ink outlet boss of the negative pressure regulator is inserted into the ink inlet.

16. The inkjet printer of claim 8, wherein the ink discharge unit comprises:
an ink outlet formed through the lateral wall of the housing;
a stopper having a predetermined diameter to block the ink outlet; and
a resilient member that applies an elastic force to the stopper against the ink outlet.

17. The inkjet printer of claim 16, wherein the ink outlet is opened when the stopper of the ink outlet is pushed in a direction opposite to a direction of the elastic force of the resilient member of the ink outlet when the ink inlet boss of the negative pressure regulator is inserted into the ink outlet.

18. The inkjet printer of claim 8, wherein the ink tank further includes a sensor that detects a level of ink in the ink tank and that notifies a user when an ink level in the ink tank is below a predetermined level.

19. The inkjet printer of claim 18, wherein the predetermined level is farther from the bottom of the ink tank than the filter of the filter unit such when the user is notified that the ink level in the ink tank is below the predetermined level, the ink level has not dropped to below the filter.
